(19) United States
(12) Patent Application Publication
(10) Pub. No.: US 2025/0067565 A1
(43) Pub. Date: Feb. 27, 2025

(54) COMMUNICATION MANAGEMENT DEVICE, COMMUNICATION MANAGEMENT METHOD, AND RECORDING MEDIUM

(71) Applicant: NEC CORPORATION, Minato-ku, Tokyo (JP)

(72) Inventors: Masayuki TAKEKAWA, Tokyo (JP); Kosei KOBAYASHI, Tokyo (JP); Masaaki TAKEUCHI, Tokyo (JP)

(73) Assignee: NEC CORPORATION, Minato-ku, Tokyo (JP)

(21) Appl. No.: 18/724,723

(22) PCT Filed: Feb. 10, 2022
(86) PCT No.: PCT/JP2022/005283

§ 371 Date: Jun. 27, 2024

(51) Int. Cl. G01C 21/34; G01C 21/36

(52) U.S. Cl. CPC G01C 21/3461; G01C 21/3492; G01C 21/3617; G01C 21/3694

(57) ABSTRACT

A communication management device comprising: a collection unit that collects traffic route information indicating traffic route conditions in a predetermined area; a generation unit that generates a map indicating a communication mode to be preferentially used at each position in the predetermined area on the basis of the collected traffic route information; and a provision unit that provides the map to a moving body moving within the predetermined area.

### TECHNICAL FIELD

The present invention relates to a communication management device, a moving body, a communication management method, and a recording medium.

### BACKGROUND ART

PTL 1 discloses a vehicle driving assistance system including a communication unit that performs at least one or more wireless communication of vehicle-to-vehicle communication with other vehicles, road-to-vehicle communication with road equipment and the like, and Internet connection. According to the literature, the vehicle driving assistance system has a function of switching a control content of automated driving related to the vehicle to another control content or switching from the automated driving to non-automated driving when all or a part of communication by the communication unit is disabled.

PTL 2 discloses an example of a communication control device that controls a communication scheme between a moving body moving along a predetermined trajectory and base stations arranged at predetermined intervals along the trajectory. According to the literature, the communication control device includes a communication scheme storage unit that stores communication schemes to be used at points, respectively, along the trajectory, a position acquisition unit that acquires a point where the moving body exists from the moving body, and a switching control unit. Then, the communication control device reads a communication scheme associated with the point acquired by the position acquisition unit from the communication scheme storage unit, and outputs a request for switching to the read communication scheme to the moving body and the base station.

### CITATION LIST

### Patent Literature

PTL 1: JP 2018-077652 A

PTL 2: JP 2013-070246 A

### SUMMARY OF INVENTION

### Technical Problem

The following analysis was given by the inventor of the present invention. In PTL 1, when at least one of the vehicle-to-vehicle communication, the road-to-vehicle communication, and the Internet connection is disabled, a driving mode is changed, but there is a need to maintain a communication mode suitable for surrounding conditions.

In this regard, in PTL 2, it is proposed to determine, based on the time when the moving bodies adjacently travel or the electrolytic strength actually measured at a plurality of points on the trajectory, the communication schemes to be used at the respective points, but there is a problem that a communication scheme suitable for the surrounding conditions is not always selected.

An object of the present invention is to provide a communication management device, a moving body, a communication management method, and a program that enable selection of a communication mode of a moving body according to a condition of a traffic route.

### Solution to Problem

According to a first viewpoint, there is provided a communication management device including: a collection means configured to collect traffic route information indicating a condition of a traffic route in a predetermined area: a generation means configured to generate a map indicating a communication mode to be preferentially used at each position in the predetermined area based on the collected traffic route information: and a provision means configured to provide the map to a moving body moving in the predetermined area.

According to a second viewpoint, there is provided a moving body including: a map storage means configured to store a map provided from the communication management device described above: a position identification means configured to identify a position of the moving body: and a function of switching a communication mode with reference to a communication mode of the position of the moving body from the map.

According to a third viewpoint, there is provided a communication management method including: collecting traffic route information indicating a condition of a traffic route in a predetermined area: generating a map indicating a communication mode to be preferentially used at each position in the predetermined area based on the collected traffic route information: and providing the map to a moving body moving in the predetermined area.

According to a fourth aspect, there is provided a computer-readable recording medium storing a program for causing a computer to execute processing of: collecting traffic route information indicating a condition of a traffic route in a predetermined area: generating a map indicating a communication mode to be preferentially used at each position in the predetermined area based on the collected traffic route information: and providing the map to a moving body moving in the predetermined area.

### Advantageous Effects of Invention

According to the present invention, there is provided the communication management device, the moving body, the communication management method, and a recording medium which enable the moving body to select an appropriate communication mode according to the condition of the traffic route.

### BRIEF DESCRIPTION OF DRAWINGS

FIG. 1 is a diagram illustrating a configuration of one example embodiment of the present invention.

FIG. 2 is a flowchart illustrating an operation of the example embodiment of the present invention.

FIG. 3 is a view for describing an operation of the example embodiment of the present invention.

FIG. 4 is a view for describing an operation of the example embodiment of the present invention.

FIG. 5 is a diagram illustrating a configuration of a first example embodiment of the present invention.

FIG. 6 is a functional block diagram illustrating a configuration of a communication management device according to the first example embodiment of the present invention.

FIG. 7 is a functional block diagram illustrating a configuration of an in-vehicle terminal according to the first example embodiment of the present invention.

FIG. 8 is a flowchart illustrating an operation of the in-vehicle terminal according to the first example embodiment of the present invention.

FIG. 9 is a view for describing an operation of the communication management device according to the first example embodiment of the present invention.

FIG. 10 is a view illustrating an example of a communication mode map generated by the communication management device according to the first example embodiment of the present invention.

FIG. 11 is another view for describing an operation of the communication management device according to the first example embodiment of the present invention.

FIG. 12 is a view illustrating an example of a communication mode map generated by the communication management device according to the first example embodiment of the present invention.

FIG. 13 is a diagram illustrating a configuration of a second example embodiment of the present invention.

FIG. 14 is a functional block diagram illustrating a configuration of a communication management device according to the second example embodiment of the present invention.

FIG. 15 is a functional block diagram illustrating a configuration of a communication management device according to a third example embodiment of the present invention.

FIG. 16 is a view for describing operations of the communication management device and a vehicle according to the third example embodiment of the present invention.

FIG. 17 is a view illustrating an example of a communication mode map generated by the communication management device according to the third example embodiment of the present invention.

FIG. 18 is a diagram illustrating a configuration of a computer that can function as the communication management device or the in-vehicle terminal of the present invention.

### EXAMPLE EMBODIMENT

First, an outline of one example embodiment of the present invention will be described with reference to the drawings. The reference signs in the drawings added to this outline are attached to elements for convenience as an example for assisting understanding, and are not intended to limit the present invention to the illustrated aspects. Furthermore, connection lines between blocks in the drawings and the like referred to in the following description include both bidirectionality and unidirectionality. A unidirectional arrow schematically indicates a main signal (data) flow, and does not exclude bidirectionality. Although a port and/or an interface is provided at input and output connection points of the blocks in the drawing, the illustration thereof is omitted.

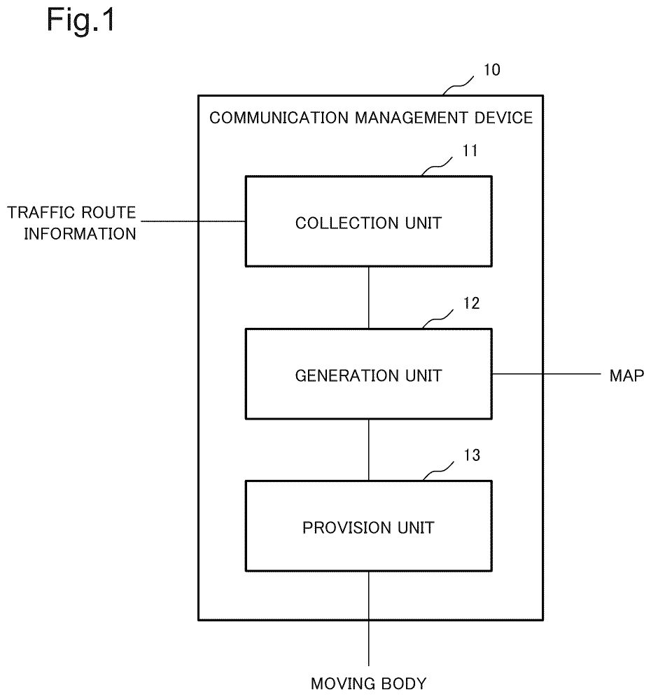

In the example embodiment, as illustrated in FIG. 1, the present invention can be achieved by a communication management device 10 including a collection means 11, a generation means 12, and a provision means 13. More specifically, the collection means 11 collects traffic route information indicating traffic route conditions in a predetermined area. As the traffic route information, various types of information, such as congestion conditions of traffic routes, the number of moving bodies, a distribution of the moving bodies, and an average speed, are conceivable. The moving body may be a pedestrian or a bicycle in addition to a vehicle. These pieces of traffic route information can be collected from various sensors, a server that manages sensor information, and the like according to contents of the traffic route information. For example, when the congestion conditions of the traffic routes are used as the traffic route information, the communication management device 10 collects the congestion conditions of the traffic routes from a traffic control server or the like that manages the congestion conditions of the traffic routes. Of course, the communication management device 10 may directly collect the congestion conditions of the traffic routes from sensors sensing the congestion conditions of the traffic routes.

The generation means 12 generates a map indicating a communication mode to be preferentially used at each position of the predetermined area based on the collected traffic route information. For example, when the congestion conditions of the traffic routes are obtained as the traffic route information, the generation means 12 generates a map defining the communication mode to be preferentially used at each position in the predetermined area based on the congestion conditions of the traffic routes.

The provision means 13 provides the map to a moving body moving in the predetermined area. The moving body that has been provided with the map performs communication while switching a communication mode according to a position of the moving body using the map.

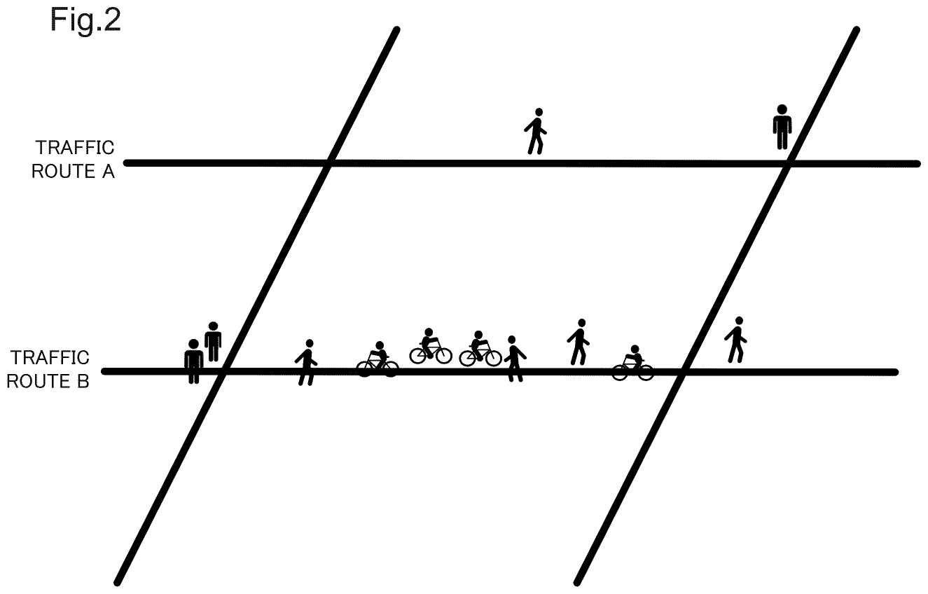

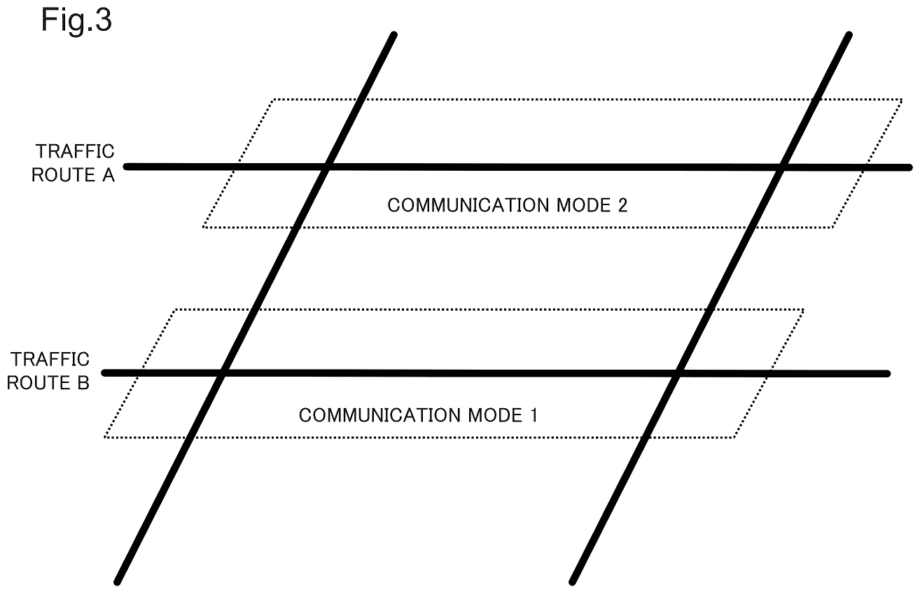

The communication management device 10 operates as illustrated in FIG. 2. First, the communication management device 10 collects traffic route information (step S001). For example, as illustrated in FIG. 3, the communication management device 10 collects congestion conditions of a traffic route A and a traffic route B in a certain area. In the example of FIG. 3, the traffic route A has few pedestrians and the like, and the traffic route B is in a condition of being congested with many pedestrians and bicycles.

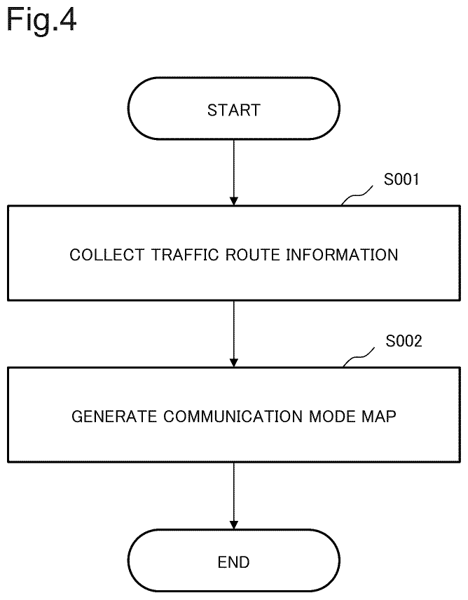

Next, the communication management device 10 generates a map indicating a communication mode to be preferentially used at each position of the predetermined area based on the collected traffic route information (step S002). FIG. 4 illustrates an example of the map generated by the communication management device 10 when the traffic route information as illustrated in FIG. 3 is obtained. In the example of

FIG. 4, it is defined to use a communication mode 1 with a short delay for the traffic route B and to use a communication mode 2 allowing a longer delay as compared with the communication mode 1 for the traffic route A. In the above example, the communication mode 1 has been described as a low-delay communication mode, and the communication mode 2 has been described as a delayed communication mode, but the communication mode 1 may be a communication mode in which large-capacity communication can be performed, and the communication mode 2 may be a communication mode having a limit in the capacity as compared with the communication mode 1.

The map generated as described above is provided from the communication management device 10 to the moving body in response to a request from the moving body or at a timing such as a predetermined time interval. The moving body that has been provided with the map switches a communication mode with reference to the map during moving in the area.

As described above, the moving body performs communication using the communication mode 1 with a short delay on the traffic route B. As a result, various types of information can be transmitted and received by low-delay communication to secure safety during passage through the congested traffic route B as illustrated in FIG. 3. On the other hand, on the non-congested traffic route A, the moving body performs communication using the communication mode 2 allowing a longer delay as compared with the communication mode 1. Since the traffic route A is not congested as illustrated in FIG. 3, it is sufficient to use a communication mode allowing a delay, and communication resources can be effectively utilized.

As the “communication mode”, various contents, such as a bit rate in data, a priority of communication, a communication protocol to be used, and the like can be set in addition to a network to be connected according to an application program or a service used by the moving body.

### First Example Embodiment

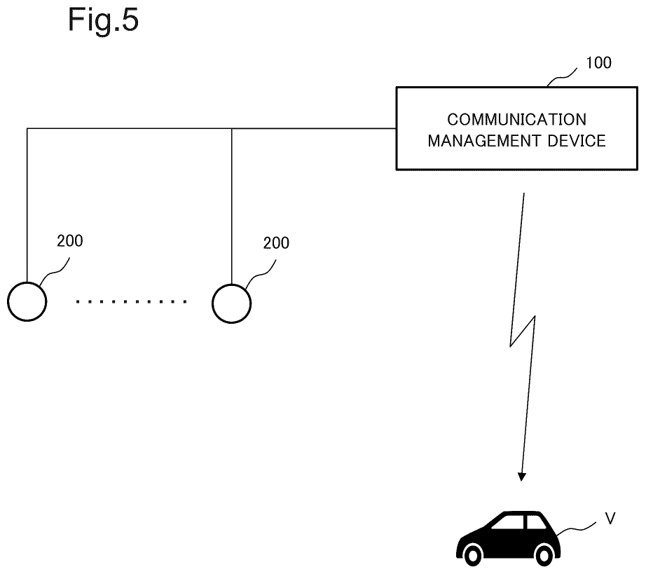

Next, a first example embodiment of the present invention will be described in detail with reference to the drawings. FIG. 5 is a diagram illustrating a configuration of the first example embodiment of the present invention. Referring to FIG. 5, a plurality of sensors 200 arranged in a predetermined area, a communication management device 100 capable of collecting traffic route information indicating traffic route conditions from these sensors 200, and a vehicle V that receives a communication mode map from the communication management device 100 are illustrated.

The sensors 200 are sensors that are arranged in a management target area of communication management device 100 and measure a traffic volume of a road in the management target area. As the sensors 200, not only a sensor for measuring the traffic volume but also other sensors such as a sensor installed for monitoring may be used. Objects to be measured for the “traffic volume” are not limited to vehicles, and may include a pedestrian and a bicycle. As a device used for measuring these, a laser, a radar, light detection and ranging (LiDAR), or the like may be used. It is also possible to adopt a method of measuring the traffic volume by capturing an image using a camera and analyzing the image.

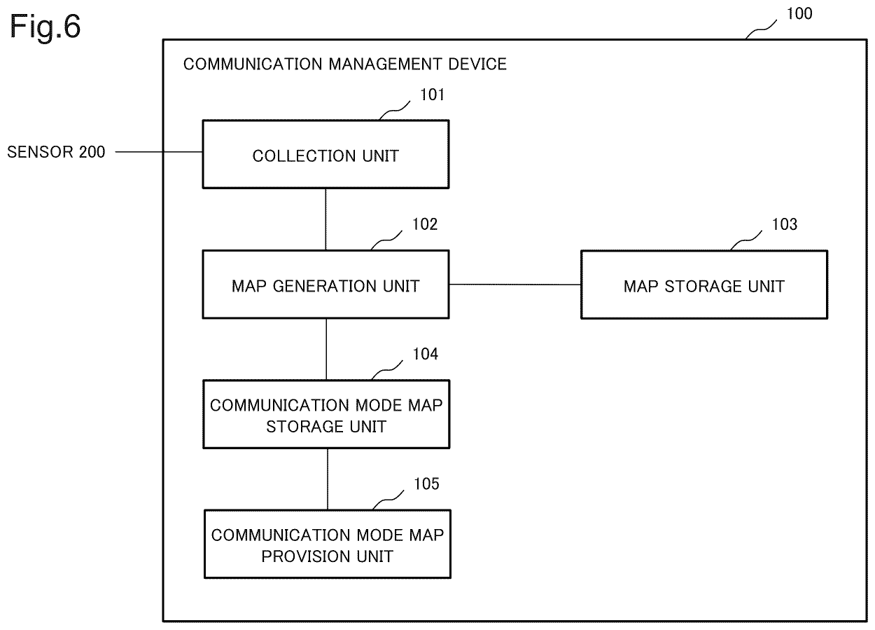

FIG. 6 is a functional block diagram illustrating a configuration of the communication management device 100 according to the present example embodiment. Referring to FIG. 6, a configuration including a collection means 101, a map generation means 102, a map storage means 103, a communication mode map storage means 104, and a communication mode map provision means 105 is illustrated.

The collection means 101 collects traffic volume information of each way in the management target area as the traffic route information from the sensors 200 described above. As the traffic volume information, a traffic volume of vehicles can be used. Furthermore, the traffic volume information may include a traffic volume of a pedestrian. The traffic volume of the pedestrian can be acquired by the sensors 200, but can also be inferred from the number of form terminals such as smartphones possessed by pedestrians, for example.

The map storage means 103 stores map data (map) of the management target area.

The map generation means 102 generates a communication mode map in which a communication mode to be preferentially used is added to the map data (map) of the management target area based on the traffic volume information collected by the collection means 101, and registers the communication mode map in the communication mode map storage means 104.

The communication mode map storage means 104 stores the communication mode map generated by the map generation means 102.

The communication mode map provision means 105 provides the communication mode map to the vehicle V having a function of switching a communication mode using the communication mode map. Therefore, the collection means 101, the map generation means 102, and the communication mode map provision means 105 correspond to the collection means 11, the generation means 12, and the provision means 13 in FIG. 1.

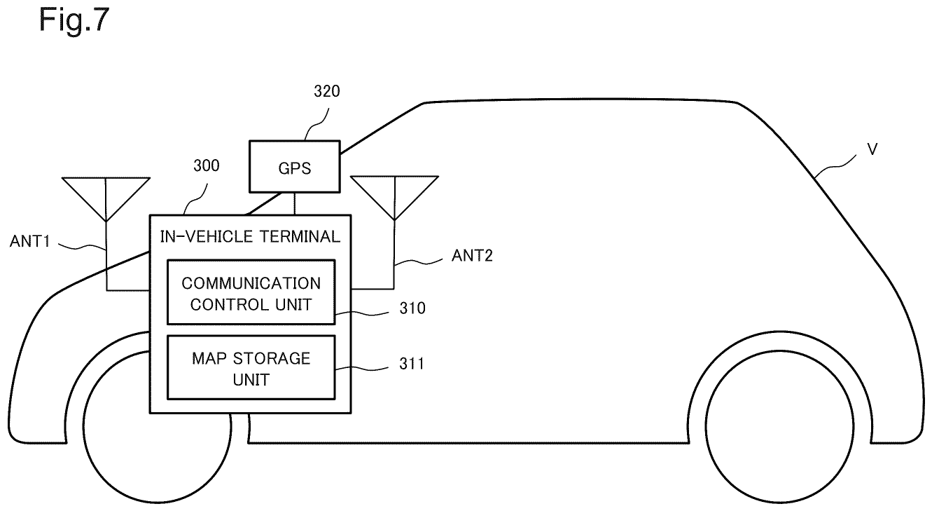

FIG. 7 is a functional block diagram illustrating a configuration of an in-vehicle terminal 300 of the first example embodiment of the present invention mounted on the vehicle V described above. Referring to FIG. 7, the in-vehicle terminal 300 including a first antenna ANT1 for connection to a first wireless network, a second antenna ANT2 for connection to a second wireless network, a communication control means 310, a map storage means 311, and a GPS 320 is illustrated.

The map storage means 311 stores a communication mode map provided from the communication management device 100. The communication mode map may store the communication mode map as a route guidance map held by a car navigation system or the like. Furthermore, the communication mode map may be stored as additional information associated with the route guidance map or a map that can be superimposed on the route guidance map.

The global positioning system (GPS) 320 acquires position information of the vehicle V. The GPS 320 is an aspect of a position identification means for identifying a position of a moving body.

The communication control means 310 reads a communication mode associated with the position of the own vehicle in the communication mode map of an area where the own vehicle is traveling from the map storage means 311, and controls communication with the outside of the in-vehicle terminal 300. Hereinafter, the present example embodiment will be described on the assumption that a wireless network type to be connected at each position in the area is designated as the “communication mode” in the communication mode map. Specifically, it is assumed that either 5G or LTE is defined as the wireless network type to be connected at each position in the area as the “communication mode” in the communication mode map. “5G” is an abbreviation for a fifth generation mobile communication system, and “LTE” is an abbreviation for long term evolution. Therefore, the in-vehicle terminal 300 mounted on the vehicle V has a function of selecting a wireless network to be applied at the position of the own device with reference to the communication mode map and performing communication with the outside.

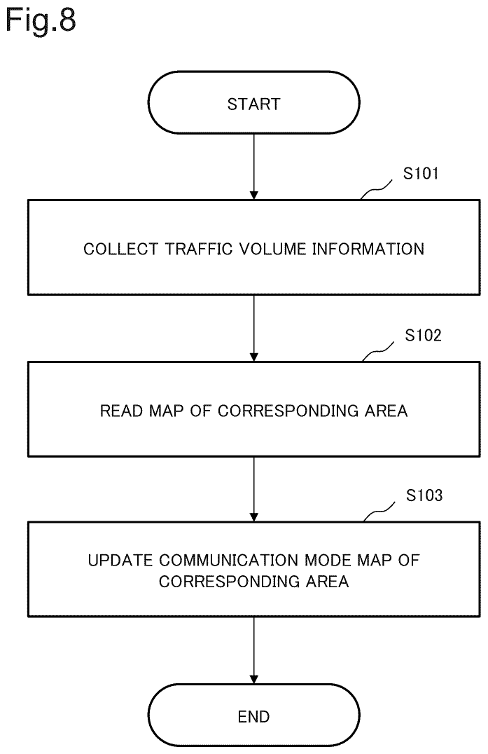

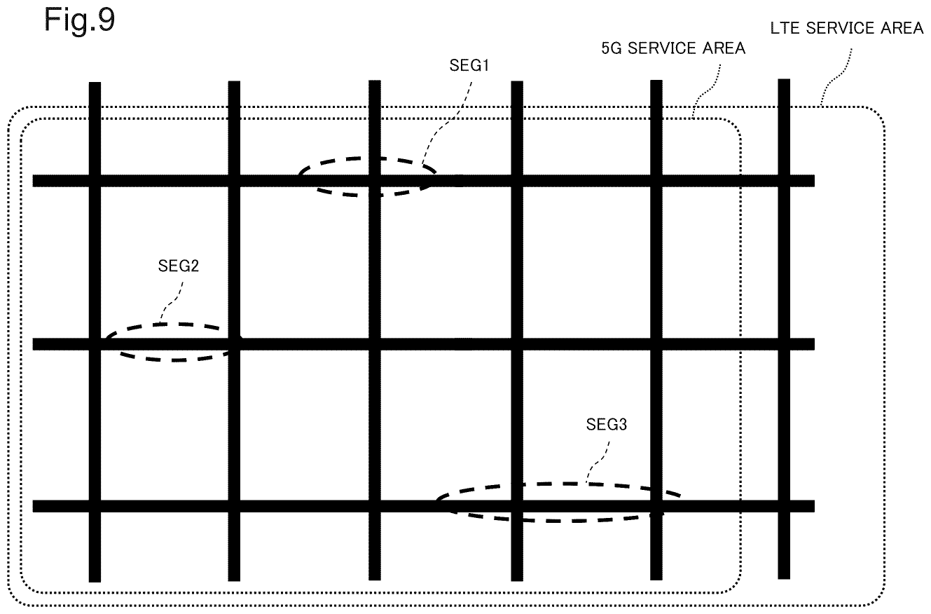

FIG. 8 is a flowchart illustrating an operation of the in-vehicle terminal according to the first example embodiment of the present invention. Referring to FIG. 8, first, the communication management device 100 collects traffic volume information from the sensors 200 (step S101). Here, description will be given on the assumption that information indicating that a traffic volume is large in sections indicated by reference signs SEG1 to SEG3 in an area illustrated in FIG. 9 is obtained.

Next, the communication management device 100 reads a map of the area of the traffic volume information obtained by the sensors 200 from the map storage means 103 (step S102).

Next, the communication management device 100 determines a communication mode to be applied at each position of the read map, and updates a communication mode map stored in the communication mode map storage means 104 (step S103).

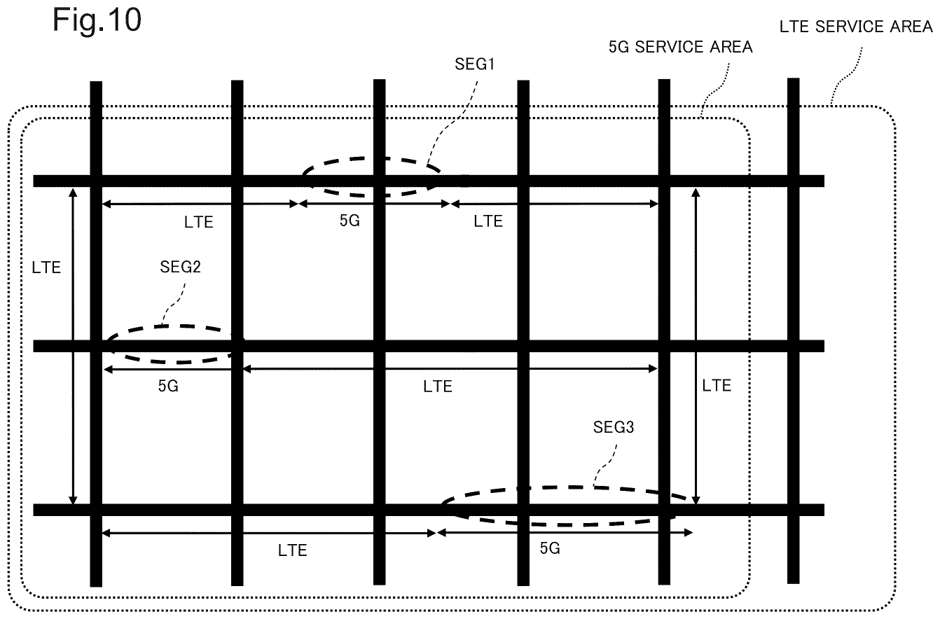

In updating the communication mode map, a communication mode selection policy defining a rule for selecting a communication mode according to a traffic route may be stored in advance. For example, in a case where a communication mode selection policy defining connection to 5G in a section with a large traffic volume and connection to LTE in the other sections is set, the communication management device 100 generates a communication mode map as illustrated in FIG. 10. In the example of FIG. 10, connection to 5G is defined in the sections SEG1 to SEG3 in which a traffic volume is large among roads in the area are connected to 5G.

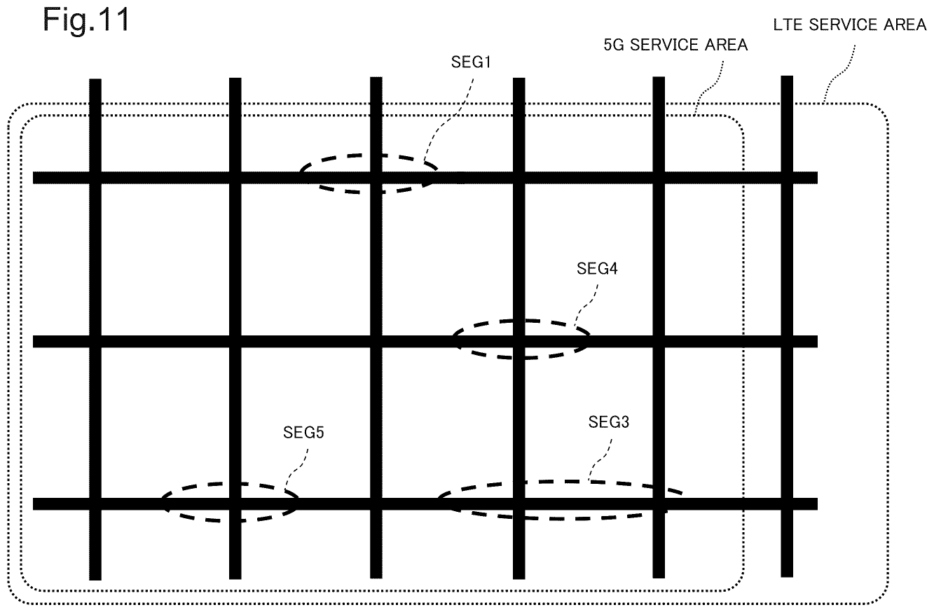

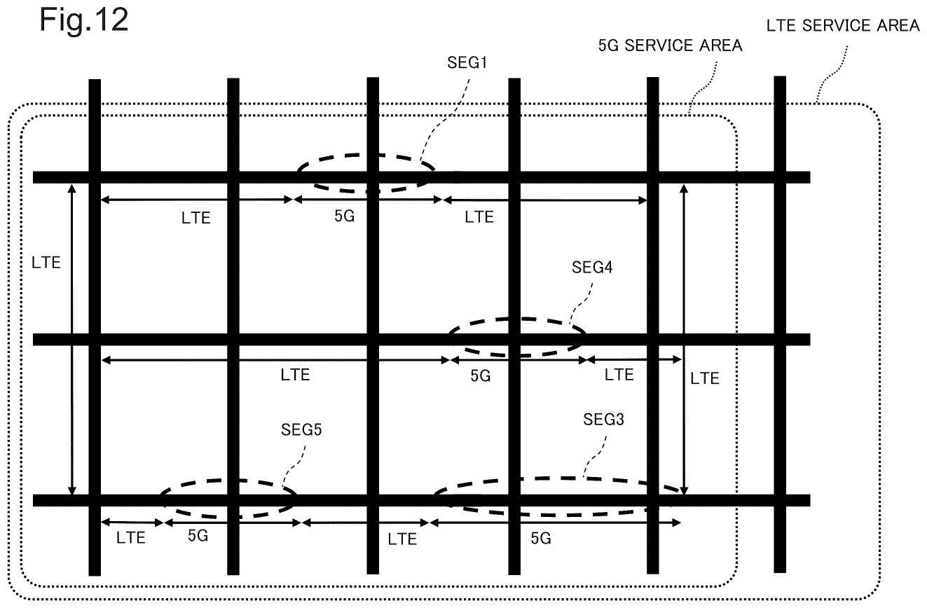

The communication mode map is preferably updated at predetermined time intervals. In this manner, it is possible to instruct the vehicle V of an appropriate communication mode according to a change in the traffic volume information. For example, in a case where a section with a large traffic volume, such as SEG4, is newly detected in addition to SEG1 to SEG3 as illustrated in FIG. 11, the communication management device 100 generates a communication mode map to give an instruction for the connection to 5G also in the section corresponding to the reference sign SEG4 as illustrated in FIG. 12.

The communication mode map generated and updated as described above is provided to the vehicle V and used to select a communication mode during traveling in the area. For example, when the vehicle V enters the section indicated by the reference sign SEG1, the in-vehicle terminal 300 mounted on the vehicle V switches the wireless network to be connected from LTE to 5G. As a result, the vehicle V can receive a large-capacity and low-delay service in accordance with 5G and travel safely in the section with a large traffic volume. On the other hand, since the vehicle V selects LTE in the other sections with a small traffic volume, radio resources of 5G can be saved.

Furthermore, the vehicle V may be a self-driving vehicle or a remote control vehicle. When the present invention is applied to these vehicles, it is possible to add an automatic switching function of a communication mode based on a traffic volume or the like to these vehicles. There is a case where the self-driving vehicle or the remote control vehicle is required to perform large-capacity and low-delay communication for remote video monitoring or remote control instruction when a traffic volume is large. When the present invention is applied, it is possible to select an appropriate communication mode in such a case.

### Second Example Embodiment

The description has been given on the assumption that the communication management device 100 collects the traffic volume information from the sensors 200 in the first example embodiment described above, but a case where a target area includes a road section where the sensor 200 is not provided is also conceivable. Next, a second example embodiment in which traffic volume information can be obtained for a section without the sensor 200 and an appropriate communication mode map can be generated will be described

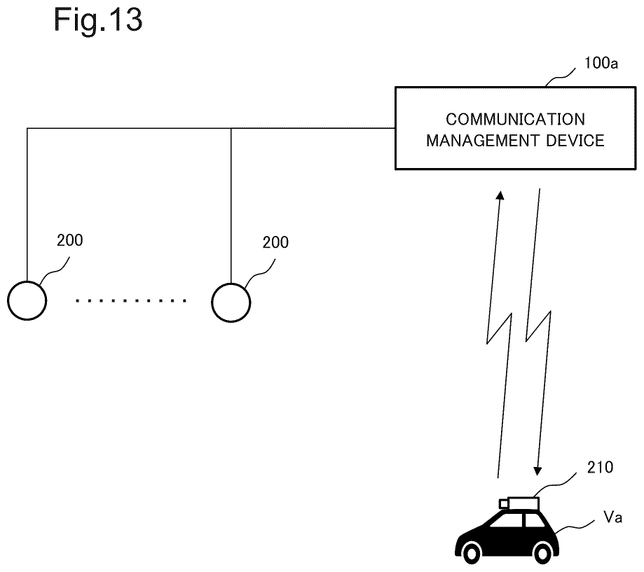

FIG. 13 is a diagram illustrating a configuration of the second example embodiment of the present invention. A difference from the first example embodiment illustrated in FIG. 5 is that a vehicle Va includes a camera 210 and is configured to be able to transmit an image of a traveling road to a communication management device 100a side.

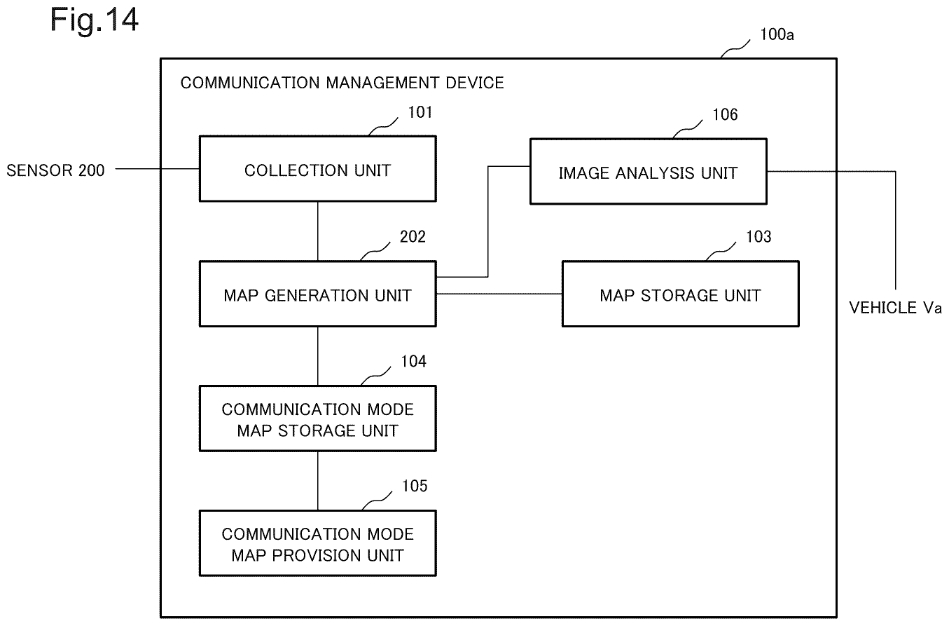

FIG. 14 is a functional block diagram illustrating a configuration of the communication management device 100a according to the second example embodiment of the present invention. A difference from the first example embodiment 100 illustrated in FIG. 6 is that an image analysis means 106 is added, and a map generation means 202 generates a communication mode map based on traffic volume information obtained by image analysis of the image analysis means 106. Since the other configurations are similar to those of the first example embodiment, the differences will be mainly described hereinafter.

The image analysis means 106 extracts vehicles appearing on the image received from the vehicle Va, estimates a traffic volume, and sends the result as the traffic volume information to the map generation means 202. A captured position on the image can be identified from position information of the vehicle Va added to the image, a terrain appearing on the image, and the like.

In addition to the collection means 101, the map generation means 202 generates the communication mode map based on the traffic volume information obtained by image analysis of the image analysis means 106.

Since operations of the present example embodiment are similar to those of the first example embodiment except that image analysis processing of the image analysis means is added, the description thereof will be omitted.

As described above, it is possible to generate an appropriate communication mode map also for an area including a road section in which the sensor 200 has failed or a road section without the sensor 200 according to the present example embodiment. Furthermore, the vehicle Va that sends the image to the communication management device 100a is not necessarily a control target vehicle that performs communication with reference to a communication mode. For example, a system administrator or the like may cause a dedicated investigation (image capturing) vehicle to travel as necessary to collect required data.

Although the communication management device 100a receives the image of the traveling road from the vehicle Va in the example embodiment described above, the communication management device 100a may collect other sensed information from the vehicle Va. Examples of the sensed information include the number of oncoming vehicles that the vehicle passes by, the number of pedestrians detected by surrounding sensors, an average speed of the vehicle during traveling in the road section, the number of times of braking, and the like. The communication management device 100a estimates a traffic volume of the road section using these pieces of information, and determines a communication mode. As a device used for measuring these, a laser, a radar, a LiDAR, or the like may be used. Furthermore, it is also possible to adopt a method in which the vehicle Va detects other vehicles using vehicle-to-vehicle communication and estimates a traffic volume.

### Third Example Embodiment

In the first and second example embodiments described above, the communication management devices 100 and 100a determine a communication mode based on traffic volume information, but the communication mode can also be determined using information other than the traffic volume information. Hereinafter, a third example embodiment in which a communication mode map is generated based on a terrain and a blocking object around a base station will be described.

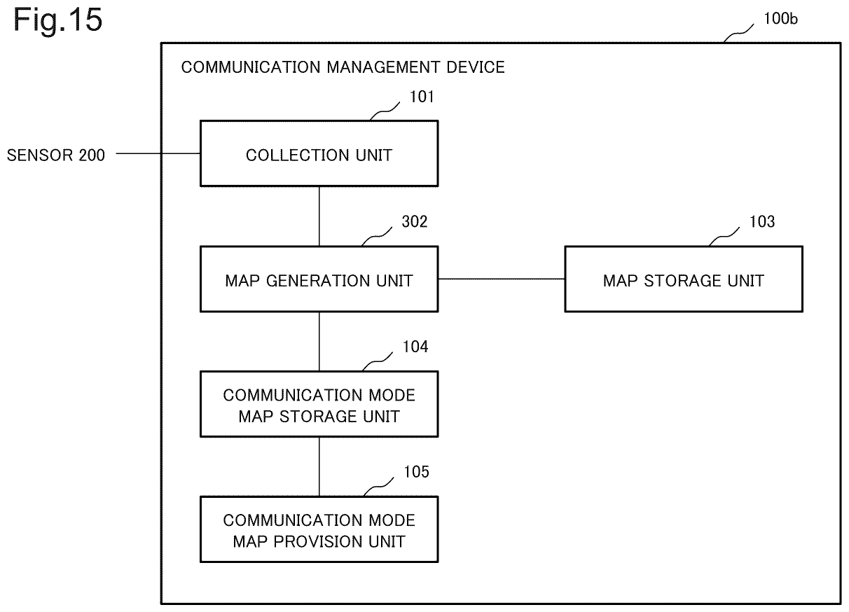

FIG. 15 is a functional block diagram illustrating a configuration of a communication management device 100b according to the third example embodiment of the present invention. A difference from the communication management device 100 of the first example embodiment illustrated in FIG. 6 is that a map generation means 302 is configured to generate a communication mode map in consideration of a subsequent object, a terrain, and the like between a position of the base station on a map and each position on the map in addition to the traffic volume information. Since the other configurations are similar to those of the first example embodiment, differences in operations will be mainly described hereinafter.

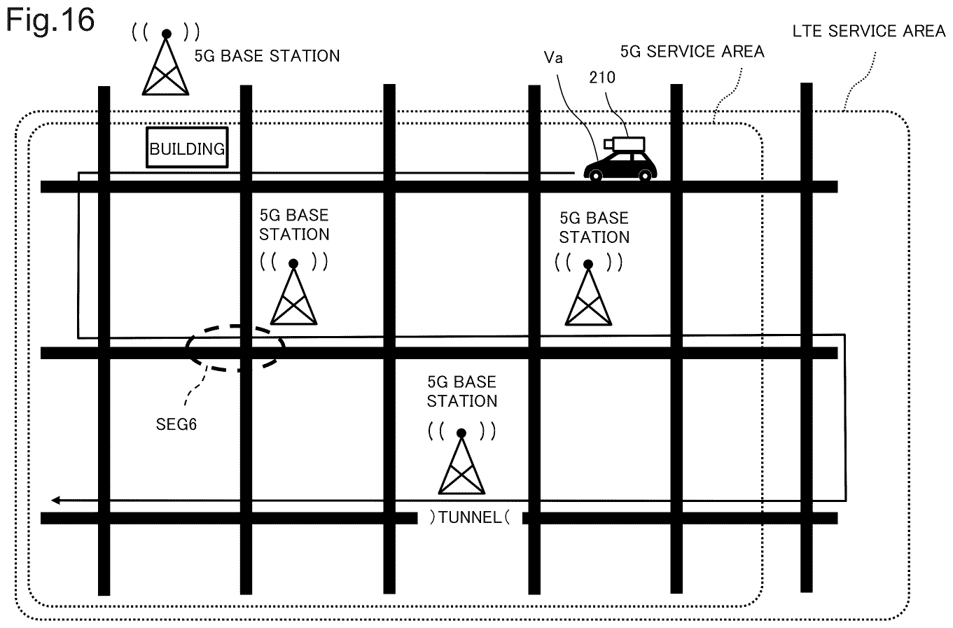

FIG. 16 is a view for describing operations of the communication management device and a vehicle according to the third example embodiment of the present invention. A difference from the map illustrated in FIG. 9 or the like is that positions and sizes of base stations (5G base stations) and blocking objects such as a building and a tunnel around the base stations are illustrated on a map. The map generation means 302 of the present example embodiment generates the communication mode map in which a communication mode is set in consideration of the positions and sizes of the base stations and the surrounding blocking objects in addition to the traffic volume information, and registers the communication mode map in the communication mode map storage means 104.

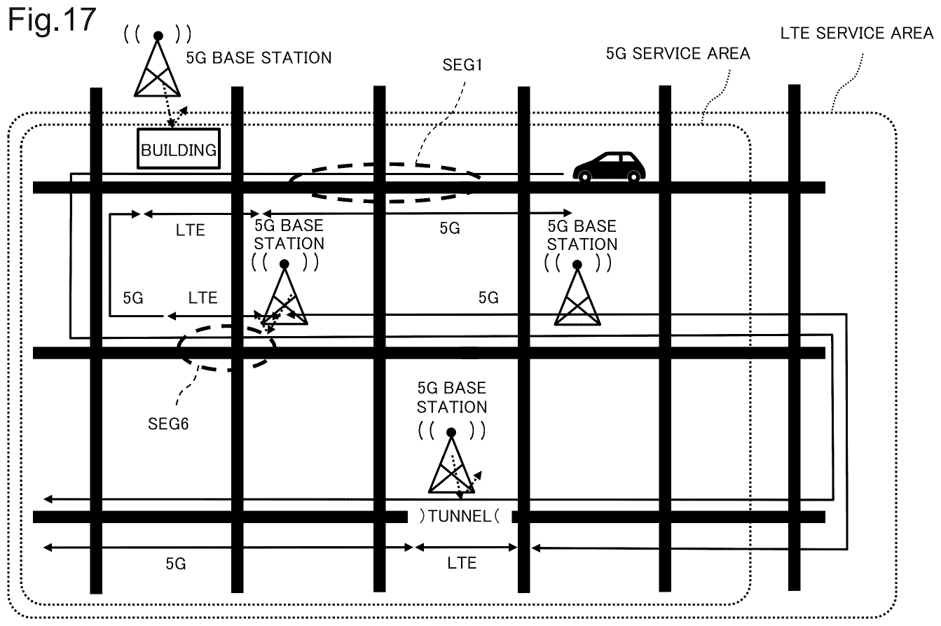

FIG. 17 is a view illustrating an example of the communication mode map generated by the communication management device 100b of the present example embodiment. For example, a 5G base station exists in the upper left of FIG. 17, but the building exists between the 5G base station and a road, and there is a possibility that radio waves from the 5G base station are blocked. Furthermore, there is a tunnel below a base station in the lower part of FIG. 17, and there is a possibility that radio waves from the 5G base station are blocked in the tunnel. The communication management device 100b generates the communication mode map defining that other wireless networks (“LTE” in the case of FIG. 17) are used for sections where radio waves from these base stations are hard to reach.

According to the present example embodiment operating as described above, it is possible to generate the communication mode map defining the communication mode in consideration of not only a traffic volume but also the presence of the blocking object and the terrain in the area. Although the description has been given on the assumption that the communication management device 100b does not analyze an image from the vehicle in the third example embodiment, but the image from the vehicle may be analyzed as in the second example embodiment. Furthermore, in a case where a blocking object and a terrain appears in the image from the vehicle, the communication management device 100b may generate a communication mode map using these. For example, the communication management device 100b can also adopt a configuration in which the presence of a blocking object is detected from an image of a building or a tunnel appearing on the image sent from the vehicle.

Although the description has been given on the assumption that the communication management devices 100, 100a, and 100b generate a communication mode map defining a wireless network to be connected in the above example embodiments, a communication mode is not limited to the wireless network to be connected. For example, the communication management devices 100, 100a, and 100b may generate a communication mode map including designation of a bit rate of video data to be transmitted at each position in a predetermined area. By switching the bit rate based on such a map, it is possible to receive provision of an image with a large amount of information according to a traffic volume from a moving body.

Although not specifically mentioned in the above example embodiments, the communication management devices 100, 100a, and 100b may generate a map defining a communication mode for each application program used on an in-vehicle device side.

Although the example embodiments of the present invention have been described above, the present invention is not limited to the above-described example embodiments, and further modifications, substitutions, and adjustments can be made without departing from the basic technical concept of the present invention. For example, a configuration of a system, a configuration of each element, and an expression form of data or the like illustrated in the drawings are examples for facilitating the understanding of the present invention, and are not limited to the configurations illustrated in the drawings. For example, the description has been given on the assumption that a moving body is a vehicle (automobile) in the first to third example embodiments described above, but the present invention can also be applied to other moving bodies. For example, the present invention can also be applied to a railway vehicle, an unmanned aerial vehicle (UAV), an automatic guided vehicle, and the like which have a communication function. In this case, a “traffic route” is a traffic route depending on a type of each of the moving bodies.

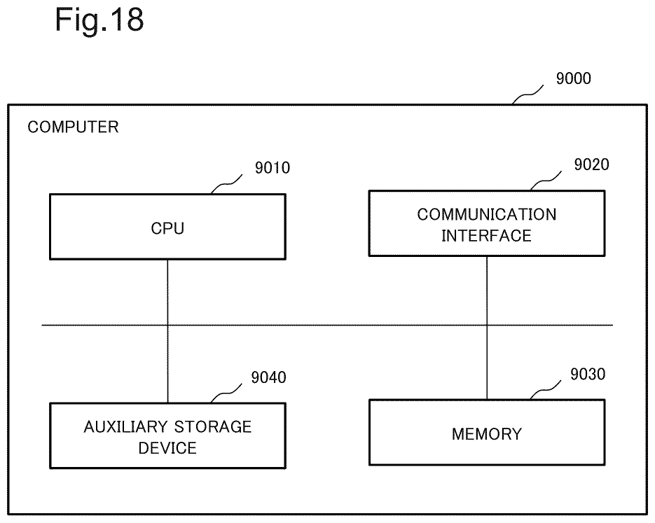

Furthermore, a procedure described in each of the above example embodiments can be achieved by a computer that functions as devices constituting each of the communication management devices 10 and 100 to 100b. Specifically, the procedure can be achieved according to a program for causing the computer (9000 in FIG. 18) to implement functions as these devices. Such a computer is exemplified to include a central processing unit (CPU) 9010, a communication interface 9020, a memory 9030, and an auxiliary storage device 9040 in FIG. 18. That is, it is sufficient to execute an information collection program and a map generation program using the CPU 9010 of FIG. 18.

That is, each unit (processing means or function) of the communication management devices 10 and 100 to 100b can be achieved according to a computer program for causing a processor mounted on these devices to execute each processing described above using hardware.

Furthermore, this computer program can be recorded on a computer-readable (non-transitory) recording medium. That is, the present invention can also be embodied as a computer program product.

Some or all of the above example embodiments may be described as the following supplementary notes, but are not limited to the following.

### [Supplementary Note 1]

A communication management device including:
a collection means configured to collect traffic route information indicating a condition of a traffic route in a predetermined area;
a generation means configured to generate a map indicating a communication mode to be preferentially used at each position in the predetermined area based on the collected traffic route information: and
a provision means configured to provide the map to a moving body moving in the predetermined area.

### [Supplementary Note 2]

The collection means of the above-described communication management device may adopt a configuration in which a traffic volume om a road section in the predetermined area is collected as the traffic route information.

### [Supplementary Note 3]

The traffic volume collected by the above-described communication management device may include a traffic volume of a pedestrian in the road section in the predetermined area.

### [Supplementary Note 4]

The collection means of the above-described communication management device may adopt a configuration in which information sensed by a moving body on the traffic route is collected as the traffic route information from the moving body.

### [Supplementary Note 5]

The generation means of the above-described communication management device may adopt a configuration in which a map including designation of a wireless network to be used at each position in the predetermined area is generated.

### [Supplementary Note 6]

The generation means of the above-described communication management device may adopt a configuration in which a map defining a communication mode to be used for each application program is generated.

### [Supplementary Note 7]

The generation means of the above-described communication management device may adopt a configuration in which a map including designation of a bit rate of video data to be transmitted at each position in the predetermined area is generated.

### [Supplementary Note 8]

The provision means of the above-described communication management device may adopt a configuration in which the map is provided to a self-driving vehicle or a remote control vehicle moving in the predetermined area.

### [Supplementary Note 9]

a map storage means configured to store a map provided from the above-described communication management device;
a position identification means configured to identify a position of the moving body; and
a function of switching a communication mode based on a communication mode associated with the position of the moving body in the map.

### [Supplementary Note 10]

A communication management method including:
collecting traffic route information indicating a condition of a traffic route in a predetermined area;
generating a map indicating a communication mode to be preferentially used at each position in the predetermined area based on the collected traffic route information; and
providing the map to a moving body moving in the predetermined area.

### [Supplementary Note 11]

A computer-readable recording medium storing a program for causing a computer to execute processing of:
collecting traffic route information indicating a condition of a traffic route in a predetermined area;
generating a map indicating a communication mode to be preferentially used at each position in the predetermined area based on the collected traffic route information; and
providing the map to a moving body moving in the predetermined area.

Modes of Supplementary Notes 9 and 10 can be developed into modes of the Supplementary Notes 2 to 8 similarly to Supplementary Note 1.

The disclosures of the above patent literatures are incorporated herein by reference thereto. Changes and adjustments of the exemplary embodiments or examples are possible within a scope of the overall disclosure (including the claims) of the present invention and based on the basic technical concept of the present invention. Furthermore, various combinations or selections (including partial deletions) of various disclosed elements (including elements of claims, elements of the example embodiments or examples, elements of the drawings, and the like) are possible within the scope of the claims of the present invention. That is, it is a matter of course that the present invention includes various modifications and variations that could be made by those skilled in the art in accordance with the overall disclosure including the claims and the technical concept. In particular, for numerical ranges set forth herein, any numerical value or sub-range included within the range should be construed as being specifically described, even if not stated otherwise.

### REFERENCE SIGNS LIST

10 communication management device
11, 101 collection means
12 generation means
13 provision means
101 collection means
102, 202, 302 map generation means
103 map storage means
104 communication mode map storage means
105 communication mode map provision means
200 sensor
210 camera
300 in-vehicle terminal
310 communication control means
311 map storage means
320 GPS
ANT1 first antenna
ANT2 second antenna
V, Va vehicle
9000 computer
9010 CPU
9020 communication interface
9030 memory
9040 auxiliary storage device

What is claimed is:

1. A communication management device comprising:
a memory; and
at least one processor coupled to the memory
the at least one processor performing operations to:
collect traffic route information indicating a condition of a traffic route in a predetermined area;
generate a map indicating a communication mode to be preferentially used at each position in the predetermined area based on the collected traffic route information; and
provide the map to a moving body moving in the predetermined area.

2. The communication management device according to claim 1, wherein the at least one processor further performs operation to:
collect a traffic volume in a road section in the predetermined area as the traffic route information.

3. The communication management device according to claim 2, wherein
the traffic volume includes a traffic volume of a pedestrian in the road section in the predetermined area.

4. The communication management device according to claim 1, wherein the at least one processor further performs operation to:
collect information sensed by a moving body on the traffic route as the traffic route information from the moving body.

5. The communication management device according to claim 1, wherein the at least one processor further performs operation to:
generate a map including designation of a wireless network to be used at each position in the predetermined area.

6. The communication management device according to claim 5, wherein the at least one processor further performs operation to:
generate a map defining a communication mode to be used for each application program.

7. The communication management device according to claim 1, wherein the at least one processor further performs operation to:
generate a map including designation of a bit rate of video data to be transmitted at each position in the predetermined area.

8. The communication management device according to claim 1, wherein the at least one processor further performs operation to:
provide the map to a self-driving vehicle or a remote control vehicle moving in the predetermined area.

9. (canceled)

10. A communication management method comprising:
collecting traffic route information indicating a condition of a traffic route in a predetermined area;
generating a map indicating a communication mode to be preferentially used at each position in the predetermined area based on the collected traffic route information; and
providing the map to a moving body moving in the predetermined area.

11. A non-transitory computer-readable recording medium storing a program for causing a computer to execute processing of:
collecting traffic route information indicating a condition of a traffic route in a predetermined area;
generating a map indicating a communication mode to be preferentially used at each position in the predetermined area based on the collected traffic route information; and
providing the map to a moving body moving in the predetermined area.
